(19) United States
(12) Patent Application Publication
(10) Pub. No.: US 2007/0075676 A1
(43) Pub. Date: Apr. 5, 2007

(54) Removable battery charger

(76) Inventor: Frank T. Novak, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/244,456

(22) Filed: Oct. 5, 2005

(51) Int. Cl. H02J 7/00

(52) U.S. Cl. 320/101

(57) ABSTRACT

An apparatus for charging a battery for an electronic device is described. The apparatus includes an array of photovoltaic elements for converting light energy into electrical energy. The apparatus also includes a storage element for storing electrical energy received from the array of photovoltaic elements, and an electrical cord to provide an electrical connection between the storage element and the battery. The array of photovoltaic elements and the storage element are affixed to a mounting that is attachable to and detachable from the electronic device.

### TECHNICAL FIELD

Embodiments of the present invention relate to electronic devices. In particular, embodiments of the present invention pertain to a battery charger.

### BACKGROUND ART

Power consumption is of particular concern to limited-power electronic devices (battery-powered devices) such as laptop computer systems, cell phones, personal digital assistants (PDAs), portable audio and video players, other types of hand-held devices, and the like. These devices are limited in size and weight, and therefore they typically use smaller and lighter batteries of limited capacity.

The batteries are typically rechargeable; however, recharging requires some sort of power source. Batteries can be charged by removing them from the electronic device and placing them into a cradle, which in turn is plugged into an electrical outlet. Batteries can also be charged in situ. For instance, one end of a charging device is plugged into an electrical outlet and the other end is plugged into a port on the electronic device. In addition to charging the battery, the charging device can be used to power the electronic device.

A problem with such conventional approaches is that the battery may need to be recharged but an electrical outlet may not be at hand. For example, the electronic device may be in use out of doors, for instance on a camping trip or on a small boat. The user may be forced to forego or curtail use of the electronic device or carry extra batteries.

Another problem with conventional charging approaches is that the battery or charging device needs to remain connected to the electrical outlet until the charging is complete or at least until the battery is charged to some degree. In those instances in which the battery is being charged in situ, the portable or mobile electronic device is essentially non-portable or immobile while the battery is being charged.

Accordingly, an apparatus that can be used to recharge the batteries of electronic devices and/or to power electronic devices, but does not suffer from the shortcomings described above, would be of value. Embodiments of the present invention provide such a novel apparatus.

### DISCLOSURE OF THE INVENTION

Embodiments of the present invention pertain to an apparatus for charging a battery for an electronic device. The apparatus may also be used to power the electronic device in place of or supplementing battery power. In one embodiment, the apparatus includes an array of photovoltaic elements for converting light energy into electrical energy. The apparatus also includes a storage element for storing electrical energy received from the array of photovoltaic elements, and an electrical cord to provide an electrical connection between the storage element and the battery. The array of photovoltaic elements and the storage element are affixed to a mounting that is attachable to and detachable from the electronic device.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a perspective drawing showing one embodiment of a battery charger in accordance with the present invention.

FIG. 2 is a functional block diagram of a battery charger according to one embodiment of the present invention.

FIG. 3 is a perspective drawing showing one embodiment of a battery charger coupled to an electronic device in accordance with the present invention.

FIG. 4 is a perspective drawing showing a battery charger housed in a carrying case according to one embodiment of the present invention.

FIG. 5 is a perspective drawing showing a battery charger attached to a carrying case according to one embodiment of the present invention.

FIG. 6 is a perspective drawing showing one embodiment of a universal adaptor for a battery charger in accordance with the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

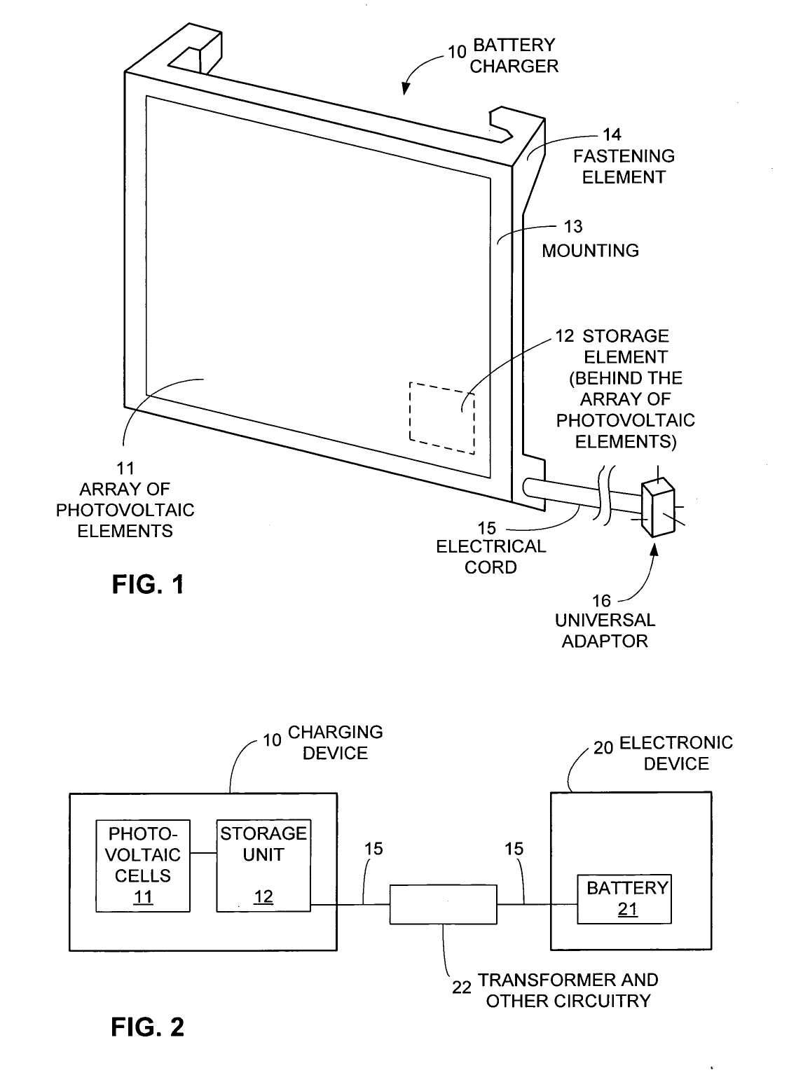

FIG. 1 is a perspective drawing showing one embodiment of a battery charger 10 in accordance with the present invention. In general, battery charger 10 includes a first element that converts solar energy or other forms of light energy into electrical energy, and a second element that stores that electrical energy. The first and second elements form an integrated unit that can be attached to an electronic device (the device on which the battery to be charged resides) or to a carrying case for the electronic device. The second (storage) element is coupled to the electronic device using some type of electrical cord. The electrical energy is transferred from the second (storage) element to a battery so that the battery can be charged. The electrical energy can also be used to power the electronic device in place of or supplementing the battery power.

Specifically, in the example of FIG. 1, battery charger 10 includes an array of one or more photovoltaic elements 11 that receive and convert ambient light—natural (solar) or artificial—and convert that light into electrical energy in a known manner. The electrical energy is stored in storage element 12, which is in general a type of capacitor or capacitive device known in the art.

In the present embodiment, the storage element 12 is located underneath or behind the photovoltaic elements 11. This allows more of the exposed surface of battery charger 10 to be available to hold the photovoltaic elements 11. That is, in the present embodiment, photovoltaic elements do not have to be displaced to make room for storage element 12, so that for a given set of dimensions, more photovoltaic elements can be incorporated into battery charger 10.

In the present embodiment, the photovoltaic elements 11 and the storage element 12 are both affixed to the same rigid or semi-rigid mounting 13, so that the photovoltaic elements 11 and storage element 12 can be operated and moved as a single unit. This feature is advantageous when battery charger 10 is being placed for use. That is, as will be seen, battery charger 10—including photovoltaic elements 11 and storage element 12—can be readily attached as a single unit to the electronic device to or to a carrying case that houses the electronic device.

Furthermore, by incorporating storage element 12 into battery charger 10 along with the photovoltaic elements 11, the battery charger 10 can be placed into a lit location, converting light into electrical energy and storing that electrical energy, even if the battery charger 10 is not electrically connected to the electronic device to be charged. When used in this manner, the battery charger 10 can be subsequently connected to an electronic device so that it can recharge the device's battery.

In the present embodiment, mounting 13 incorporates one or more fastening elements 14 that allow the battery charger 10 (including the photovoltaic elements 11 and the storage element 12) to be readily attached to and detached from, for example, the electronic device itself or to a carrying case in which the electronic device is housed. Different types of fastening elements can be used.

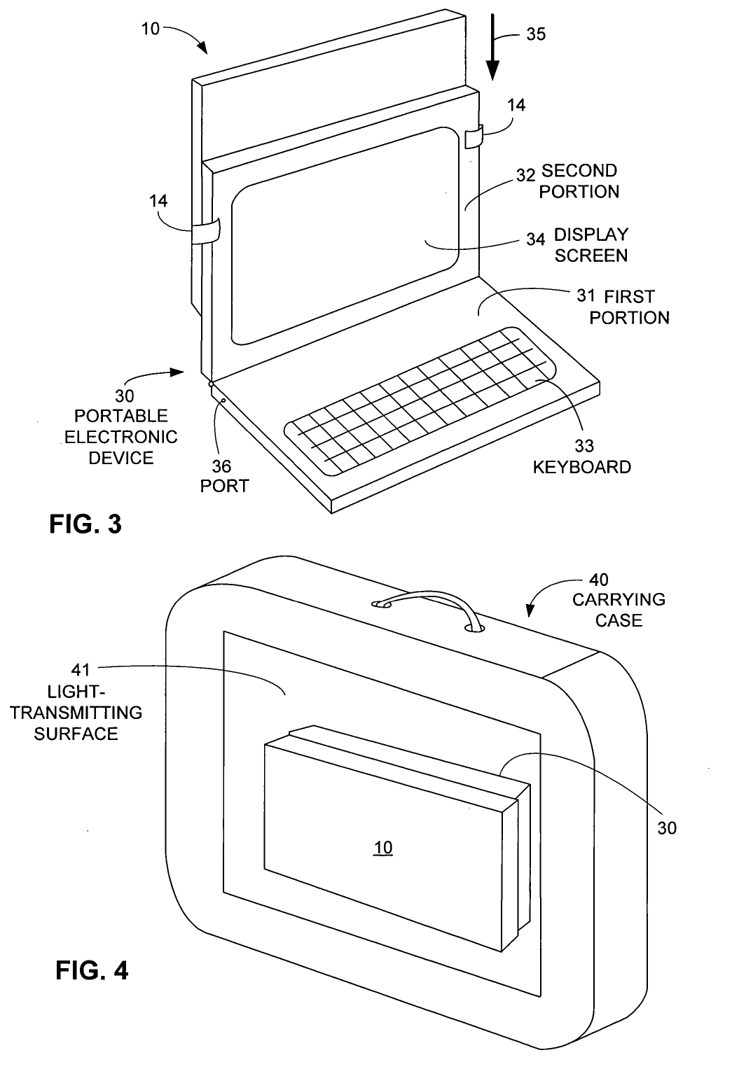

In one embodiment, the fastening elements 14 are present only on the battery charger 10; an example of this type of fastening element is described further in conjunction with FIG. 3, below. In general, battery charger 10 can be designed so that it fits onto and can be attached to conventional electronic devices without those electronic devices having to be modified in order to receive battery charger 10.

Alternatively, fastening elements may be present solely on the housing of the electronic device to be charged. As another alternative, the fastening elements may be present on both mounting 13 of FIG. 1 and the housing of the electronic device to be charged. For example, a hook-and-loop fastening element (e.g., VELCRO) may be used. As another example, the mounting 13 may incorporate tabs that are fit into grooves formed in the housing of the electronic device (or vice versa).

An electrical cord 15 provides an electrical connection between storage element 12 and the battery or device to be charged. In one embodiment, electrical cord 15 incorporates a universal adaptor 16, which can be plugged into a conventional charging port of the electronic device to be charged. The universal adaptor is described further in conjunction with FIG. 6, below.

FIG. 2 is a functional block diagram of a battery charger (charging device) 10 according to one embodiment of the present invention. As mentioned above, battery charger 10 includes an array of photovoltaic elements (cells) 11 and a storage unit 12. Electrical cord 15 provides an electrical connection between the storage unit 12 and the battery 21 of electronic device 20.

In one embodiment, electrical cord 15 includes a transformer and other circuitry 22, which are used to adapt the electrical energy stored in storage unit 12 to match the characteristics (e.g., the voltage and current requirements) of battery 21. In another embodiment, the transformer and other circuitry 22 are contained within the battery charger 10.

Battery 21 may be any of the conventional rechargeable battery types in use, such as but not limited to lithium ion or lithium sulfur batteries.

In one embodiment, electrical cord 15 is hardwired to battery charger 10 at one end, incorporating an adaptor such as universal adaptor 16 (FIG. 1) at the other end. In another embodiment, electrical cord 15 incorporates a plug at both ends, and battery charger 10 incorporates a port into which electrical cord 15 can be plugged. Thus, in this latter embodiment, electrical cord 15 is plugged into both electronic device 20 and battery charger 10. Accordingly, in the latter embodiment, battery charger 10 can be used with different types of transformers and other circuitry 22 and hence can be adapted for use with various types of electronic devices. Thus, for example, if the electronic device to be charged has voltage or current characteristics different from those anticipated, then battery charger 10 can still be used as a source of electrical energy by attaching the appropriate type of electrical cord 15 incorporating the appropriate type of transformer and other circuitry 22.

FIG. 3 is a perspective drawing showing one embodiment of a battery charger 10 slideably coupled to an electronic device 30 in accordance with the present invention. In the example of FIG. 3, electronic device 30 is a conventional laptop or notebook computer, with a first portion 31 incorporating, for example, a keyboard 33, and a second portion 32 incorporating, for example, a display screen 34.

In the example of FIG. 3, with the electronic device 30 in its in-use or open layout, battery charger 10 is fastened to the surface of the second portion 32 that faces away from the display screen 34. For example, the fastening elements 14 are sized and shaped so that they can be positioned along the edges of the second portion 32, and then battery charger 10 is then slid in the direction of arrow 35 so that it is attached in place to the second portion 32 of electronic device 30. Electrical cord 15 (FIG. 1) can then be plugged into input port 36.

Significantly, continuing with reference to FIG. 3, battery charger 10 can be attached to electronic device 30 without interfering with the operation of the electronic device. That is, a user can continue to use electronic device 30 even with battery charger 10 in place. As mentioned above, battery charger 10 can be used to power electronic device 30 in lieu of or as a supplement to battery 21 (FIG. 2).

In one embodiment, in order to maximize the size of battery charger 10 without increasing the footprint of the electronic device 30, the battery charger 10 has dimensions that correspond to (are not greater than) the largest dimensions of electronic device 30. That is, the length and width of battery charger 10 may be roughly the same as the length and width of the largest external surface of electronic device 30. By using a larger battery charger, more photovoltaic elements can be incorporated into battery charger 10. In one embodiment, the thickness of battery charger 10 is on the order of three-eighths of an inch, so that battery charger 10 is not expected to appreciably increase the volume of the electronic device to which it is attached.

The example of FIG. 3 can be extended to other types, sizes and shapes of electronic devices.

FIG. 4 is a perspective drawing showing a battery charger 10 housed in a carrying case 40 for an electronic device 30 according to one embodiment of the present invention. The carrying case 40 includes a light-transmitting (e.g., transparent) surface 41 through which light can pass. In the example of FIG. 4, battery charger 10 is attached to the housing of the electronic device 30, with the array of photovoltaic elements 11 (FIG. 1) aligned with the light-transmitting surface 41. In this manner, light can reach the array of photovoltaic elements 11 (FIG. 1), allowing electrical energy to accumulate in storage element 12 (FIG. 1) even as electronic device 30 is being transported in the carrying case 40. If battery charger 10 is connected (plugged into) electronic device 30, then battery 21 (FIG. 2) can be charged as electronic device 30 is being transported.

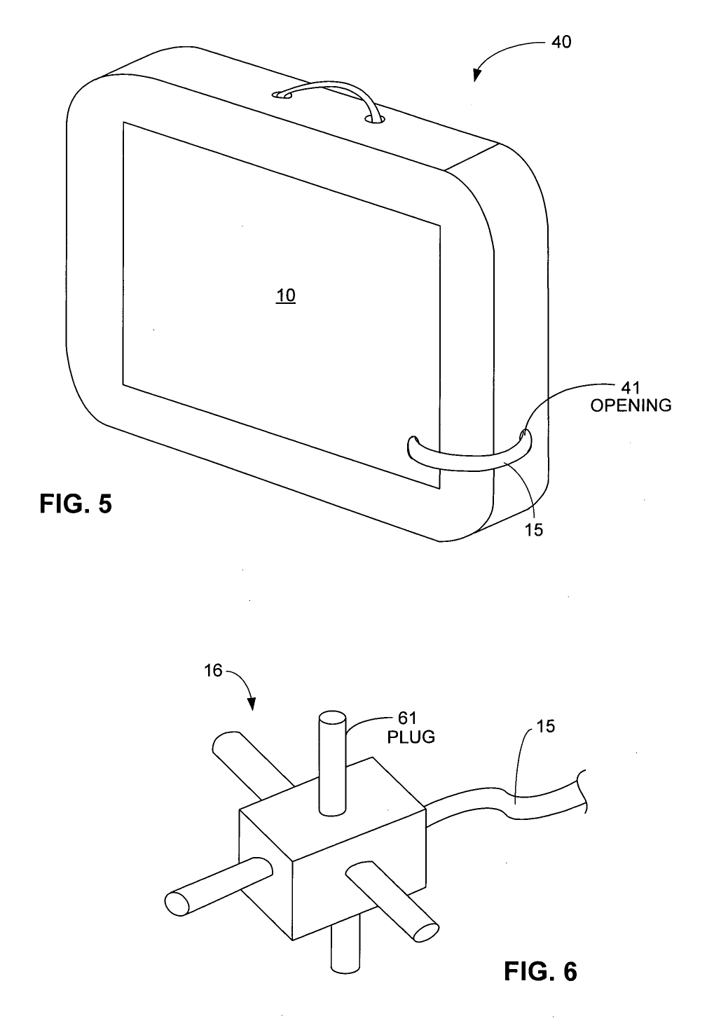

FIG. 5 is a perspective drawing showing a battery charger 10 attached to the outside of a carrying case 40 for an electronic device (not shown in FIG. 5) according to one embodiment of the present invention. In the example of FIG. 5, battery charger 10 is electrically connected to the electronic device via an opening 51 in the carrying case 40. In this manner, battery charger 10 can perform as previously described herein to accumulate electrical energy and to charge battery 21 (FIG. 2) even during transport.

FIG. 6 is a perspective drawing showing one embodiment of a universal adaptor 16 for a battery charger in accordance with the present invention. In the present embodiment, universal adaptor 16 incorporates a number of different sizes and shapes of plugs (e.g., plugs having different lengths and diameters), exemplified by plug 61. Accordingly, universal adaptor 16 and hence battery charger 10 (FIG. 1) can be used with different types of electronic devices that may have different types of input ports (e.g., input ports of different sizes and shapes).

In summary, embodiments in accordance with the present invention provide an apparatus for recharging the batteries of electronic devices and/or for powering electronic devices, in particular portable or mobile devices. As a light-based (e.g., solar) charger, the battery charger of the present invention can be used to charge and/or operate an electronic device when light is present. The present invention battery charger can be placed in a lit location—such as a clear pocket in a carrying case—so that the battery can be charged even when the electronic device is stowed away. If the battery charger is not electrically connected to the electronic device, the battery charger can still be placed in a lit location, accumulating and storing electrical energy converted from light (e.g., solar) energy, so that the battery charger can subsequently be used to charge the battery of the electronic device. For example, the battery charger can be placed on a windowsill to accumulate solar/electrical energy, and then later connected to the device or battery so that the battery can be charged.

Although described primarily in the context of in situ battery charging, embodiments in accordance with the present invention can be applied to battery chargers that utilize a cradle to hold the batteries during recharging.

Thus, according to embodiments of the present invention, even if an electrical outlet or other such source is unavailable, the electronic device can still be used or charged. Device users can be less concerned with conserving battery power, and do not have to be inconvenienced by carrying spare batteries. The battery charger can be attached to and used with different types of portable devices, ranging from (but not limited to) laptop computers to smaller handheld devices.

Embodiments of the present invention are thus described. While the present invention has been described in particular embodiments, it should be appreciated that the present invention should not be construed as limited by such embodiments, but rather construed according to the following claims.

What is claimed is:

1. An apparatus for charging a battery for an electronic device, said apparatus comprising:
an array of photovoltaic elements for converting light energy into electrical energy;
a storage element for storing electrical energy received from said array of photovoltaic elements;
a mounting to which said array of photovoltaic elements and said storage element are affixed, said mounting comprising a fastening element adapted to removably couple said mounting including said array of photovoltaic elements and said storage element to said electronic device; and
an electrical cord coupled to said storage element and adapted to provide an electrical connection between said storage element and said battery.

2. The apparatus of claim 1 wherein said electrical cord comprises a universal adaptor comprising a plurality of different-sized plugs.

3. The apparatus of claim 1 wherein the length and width of said mounting are substantially the same as the length and width of the largest external surface of the housing of said electronic device.

4. The apparatus of claim 1 wherein said electronic device comprises a first portion housing a keyboard and a second portion housing a display screen, wherein said mounting including said array of photovoltaic elements and said storage element is removably coupled to the surface of said second portion facing away from said display screen.

5. The apparatus of claim 1 wherein said electronic device and said mounting including said array of photovoltaic elements and said storage element are housed within a carrying case having a light-transmitting portion, wherein said array of photovoltaic elements is aligned with said light-transmitting portion.

6. The apparatus of claim 1 wherein said electronic device is housed within a carrying case, wherein said mounting including said array of photovoltaic elements and said storage element is removably coupled to an external surface of said carrying case.

7. The apparatus of claim 1 wherein said fastening element comprises a plurality of mounting clips that are aligned such that said mounting is slidably attached to the housing of said electronic device.

8. An electronic device comprising:
a housing;
a battery within said housing and for powering said electronic device;
a mounting to which an array of photovoltaic elements and a storage element are affixed, said array of photovoltaic elements for converting light energy into electrical energy and said storage element for storing electrical energy received from said array of photovoltaic elements, wherein said mounting including said array of photovoltaic elements and said storage element are removably coupled to said housing; and
an electrical cord coupled to said storage element and adapted to provide an electrical connection between said storage element and said battery.

9. The electronic device of claim 8 wherein said electrical cord comprises a universal adaptor comprising a plurality of different-sized plugs.

10. The electronic device of claim 8 wherein the length and width of said mounting are substantially the same as the length and width of the largest external surface of said housing.

11. The electronic device of claim 8 wherein said electronic device comprises a first portion housing a keyboard and a second portion housing a display screen, wherein said mounting including said array of photovoltaic elements and said storage element is removably coupled to the surface of said second portion facing away from said display screen.

12. The electronic device of claim 8 wherein said electronic device and said mounting including said array of photovoltaic elements and said storage element are housed within a carrying case having a light-transmitting surface, wherein said array of photovoltaic elements is aligned with said light-transmitting surface.

13. The electronic device of claim 8 wherein said fastening element comprises a plurality of mounting clips that are aligned such that said mounting is slidably attached to the housing of said electronic device.

14. A system for charging a battery of an electronic device, said apparatus comprising:
means for converting light energy into electrical energy;
means for storing electrical energy received from said means for converting;
means for removably coupling a mounting to said electronic device, wherein said means for converting and said means for storing are affixed to said mounting; and
means for electrically connecting said means for storing to said battery.

15. The system of claim 14 wherein said means for electrically connecting comprises a universal adaptor comprising a plurality of different-sized plugs.

16. The system of claim 14 wherein the length and width of said mounting are substantially the same as the length and width of the largest external surface of the housing of said electronic device.

17. The system of claim 14 wherein said electronic device comprises a first portion housing a keyboard and a second portion housing a display screen, wherein said mounting including said means for converting and said means for storing is removably coupled to the surface of said second portion facing away from said display screen.

18. The system of claim 14 wherein said electronic device and said mounting including said means for converting and said means for storing are housed within a carrying case having a light-transmitting portion, wherein said means for converting is aligned with said light-transmitting portion.

19. The system of claim 14 wherein said electronic device is housed within a carrying case, wherein said mounting including said means for converting and said means for storing is removably coupled to an external surface of said carrying case.

20. The system of claim 14 wherein said means for removably coupling comprises a plurality of mounting clips that are aligned such that said mounting is slidably attached to the housing of said electronic device.
